(19) United States
(12) Patent Application Publication
(10) Pub. No.: US 2006/0057320 A1
(43) Pub. Date: Mar. 16, 2006

(54) Accelerator-free carboxylated latex compositions and articles

(75) Inventor: Wunan Huang, Greer, SC (US)

Correspondence Address: Wunan Huang, 302 Water Mill Road, Greer, SC, 29650, US

(73) Assignee: AT TECH, INC.

(21) Appl. No.: 11/220,991

(22) Filed: Sep. 7, 2005

Related U.S. Application Data
(60) Provisional application No. 60/609,117, filed on Sep. 10, 2004.

(51) Int. Cl. B32B 1/08; B32B 27/08

(52) U.S. Cl. 428/35.7; 428/36.9

(57) ABSTRACT

Accelerator-free carboxylated latex compositions, articles made therefrom, and methods of fabricating them, are disclosed. The carboxylated latex compositions use a mixture of alkoxyalkyl alkylol melamine and zinc oxide as their cure system. Carboxylated nitrile (a terpolymer of butadiene, acrylonitrile and organic acid) gloves made according to this invention are free of accelerators and sulfur, and they have similar tensile property as nitrile gloves cured by accelerators, sulfur and zinc oxide. Furthermore, glove softness can be adjusted by varying the quantity ratio of alkoxyalkyl alkylol melamine to zinc oxide.

### THE BACKGROUND OF THE INVENTION

The invention pertains to a crosslink (cure) system, such as an accelerator-free crosslink system particularly suited for carboxylated latex. The accelerator-free system comprises alkoxyalkyl alkylol melamine and metal oxide. The accelerator-free system can, for example, produce carboxylated nitrile latex films having high tensile strength up to over 5,000 psi (pounds per square inch) and 300% modulus below 1,000 psi that are comparable to nitrile latex films produced by conventional cure system comprising accelerators, sulfur and zinc oxide.

There are two types of raw nitrile rubber: one is carboxylated and the other is non-carboxylated. Carboxylated nitrile is a terpolymer of butadiene, acrylonitrile, and organic acid while non-carboxylated nitrile is a copolymer of butadiene and acrylonitrile.

Elastomeric nitrile rubber products are typically made from a composition containing a cross-linker. Cross-linking makes possible the cured nitrile rubber products with desired physical strength. Generally, carboxylated nitrile rubber is cross-linked (cured) through covalent reaction at its double bonds of butadiene segments with accelerators and sulfur or with peroxides, and/or through ionic reaction at its carboxylic acid groups with polyvalent metal or metal oxides. Typical organic accelerators are chemical class of thiuram, carbamate and thiazole. Articles cured with accelerators and sulfur only without polyvalent metal or metal oxides are generally inferior in physical properties and heat resistance. On the other hand, articles cured with organic accelerators, sulfur, and polyvalent metal or metal oxide have good balanced physical properties. However, these two cure systems have a common disadvantage in certain applications because organic accelerators may cause Type IV allergic contact dermatitis when the articles are used to contact with human skin or tissues. Common metal oxide for curing of carboxylated nitrile rubber is zinc oxide. As described in U.S. Pat. No. 2,724,707, zinc oxide can react with carboxylic acid groups of carboxylated nitrile rubber to form cross-links through ionic bonding. Literature shows that this type of ionic bond is less flexible; therefore, under same degree of cross-linking, the carboxylated nitrile rubber cured with metal oxides alone is stiffer. Thus, it is desirable to design new accelerator-free, carboxylated nitrile latex compositions to produce gloves which have their tensile strength, modulus, and percent elongation comparable to conventional compositions containing accelerators, sulfur and zinc oxide. In the present invention, compositions containing cross-linking complex of alkoxyalkyl alkylol melamine and zinc oxide are disclosed to provide the desired features of cured carboxylated nitrile latex articles. Without being bound to a theory of operation, in the present invention it is believed that at high temperature (for example, 100 to 140° C.) metal oxide not only can react with carboxylic acid functional groups of carboxylated latex but also with hydroxyl groups of alkoxyakkyl alkylol melamine to form metallic complex ionic bonds. The use of external cross-linking agents containing no carboxylic acid or carboxylic acid derivatives is another distinct feature of this invention.

### SUMMARY OF THE INVENTION

An object of the invention is to provide carboxylated latex compositions which are free of organic rubber accelerators to eliminate Type IV allergic contact dermatitis induced by such accelerators.

Another object of this invention is to provide accelerator-free carboxylated latex articles, e.g., nitrile gloves, which have strength and softness comparable to conventional carboxylated nitrile latex gloves cured with compositions containing accelerators, sulfur and metal oxide.

Another object of this invention is to provide accelerator-free carboxylated nitrile latex gloves, which are softer than nitrile gloves cross-linked with only ionic bonding by metal oxide alone.

Another object of this invention is to provide fabrication methods for making accelerator-free carboxylated latex articles. This invention also provides methods of making carboxylated latex compositions. Carboxylated nitrile latex is used as an example for the invention. The first compounding method for preparing the compositions of the invention is a “one step” process by adding the compounding ingredients to carboxylated nitrile latex in a specified sequence. The second compounding method for preparing the compositions of the invention is a “two steps” process. The first step is the preparation of the cross-linking complex dispersion by mixing together metal oxide dispersion, alkoxyalkyl alkylol melamine organic cross-linking agent, and antioxidant dispersion. The cross-linking complex dispersion is aged first for a specified period. The second step is the adding of the aged complex dispersion and all the other compounding ingredients to carboxylated nitrile latex.

In preferred embodiments: the antioxidant is polymeric hindered phenol (butylated reaction product of para-cresol and dicyclopentadiene); the organic cross-linking agent is methoxymethyl methylol melamine with a high methylol content and a high imino functionality; the metal oxide is zinc oxide; the surface active stabilizer is sodium dodecylbenzene sulfonate; the pH adjustment solution is dilute potassium hydroxide solution; the pigments are titanium dioxide and various salts of phthalocyanine. In the preferred embodiments, the method includes the further step of maturing the compounded carboxylated nitrile latex compositions for one to three days before the compositions are used for making carboxylated nitrile latex articles, or other uses. In preferred embodiments, the method includes a further step of drying and curing the aggregated or coagulated carboxylated nitrile latex compositions to form cross-linked carboxylated nitrile latex compositions. The invention further provides cross-linked carboxylated nitrile latex compositions made by the method described above. The invention also provides articles of manufacture having a layer of the cross-linked carboxylated nitrile latex compositions formed by the method described above.

In another aspect, the invention provides cross-linked accelerator-free nitrile latex compositions made from a carboxylated nitrile latex base, a surface active stabilizer, a pH adjustment solution, an antioxidant, a cross-linking complex of an organic cross-linking agent and zinc oxide, pigments of titanium dioxide and a phthalocyanine salt. In preferred embodiments, cross-linked carboxylated nitrile latex compositions of this invention have their 300% modulus in the range of 1.7 MPa (250 psi) to 6.9 MPa (1,000 psi), tensile strength of 14.5 MPa (2,100 psi) to 37.9 Mpa (5,500 psi), and ultimate elongation in the range of 550% to 900%.

In another aspect, the invention provides carboxylated nitrile latex compositions made per any of the methods described above.

In another aspect, the invention provides articles of manufacture made from any of the carboxylated nitrile latex compositions of the invention. A preferred article of manufacture is glove. In preferred embodiments, a glove according to this invention comprises a layer of cross-linked carboxylated nitrile latex composition of the invention, the layer having a thickness of about 3 mils to about 20 mils.

### DETAILED DESCRIPTION OF THE INVENTION

The invention provides carboxylated nitrile latex compositions useful for making articles with balanced physical properties without using conventional accelerators and sulfur. Such articles are suitable for skin contact with people who have Type IV allergic contact dermatitis reaction to rubber accelerators such as thiurams, carbamates, and thiazoles. For gloves, the balanced physical properties of high tensile strength and low modulus are preferred product characteristics. In this invention, complex compounds of metal oxide and a multi-functional organic cross-linking agent are used to form cross-links instead of the conventional accelerators/sulfur system. The preferred metal oxide is zinc oxide. The multi-functional organic cross-linking agent is alkoxyalkyl alkylol melamine. The preferred organic cross-linking agent is methoxymethyl methylol melamine with a high methylol content and a high imino functionality. Metal oxide can react with carboxylic acid groups of carboxylated nitrile latex to form ionic cross-link bonds. Without being bound to theory of operation, it is believed that the alkylol and alkoxyalkyl functional groups of the organic cross-linking agent can react with carboxylic acid groups of carboxylated nitrile rubber latex to form bivalent cross-links. On the other hand, without being bound to theory of operation, it is also believed that alkylol and alkoxyalkyl can first react with zinc oxide and then with the carboxylic acid groups of carboxylated nitrile rubber latex to form ionic cross-links. Medical glove is one of the carboxylated nitrile latex articles that can be produced with the present invention. Nitrile gloves made of this composition provide advantageous features. First, they have similar tensile strength and modulus as nitrile gloves produced with conventional cure system comprising accelerators, sulfur and zinc oxide. Secondly, thermal stability of nitrile gloves with this type of cross-link is better than that of gloves with polysulfide link made from cure systems comprising sulfur. Polysulfide link has low bond energy; therefore, it is less resistance to thermal degradation. Thirdly, Type IV allergic contact dermatitis sensitization induced by rubber accelerators such as thiurams, thiazoles, and carbamates, is well-known in literature; consequently, there is a need to provide glove users with a product that is free of accelerators. Nitrile gloves produced from this invention meet this need. Other flexible nitrile latex products such as condoms, finger cots, sleeves, tubing, etc. can also be made with this invention.

I. Compositions

Carboxylated nitrile latex suitable for making articles of this invention is commercially available, for examples, Nantex 630E (Nantex Industry Co., Ltd.), Tylac 68073-06 (Dow-Reichhold Chemical), and Synthomer 99G43 (Synthomer Limited). Nantex 630E is used for illustration in this invention.

The metal compounds preferably comprise zinc, magnesium, calcium, cadmium or lead. Their representative compounds are metal oxides, such as magnesium oxide, zinc oxide, calcium oxide, cadmium oxide or lead oxide. Zinc oxide is the preferred metal compound of the invention. The preferred amount of zinc oxide is from about 0.5 to about 2.0 phr (parts per hundred parts of dry rubber) of nitrile latex rubber.

The organic cross-linking agent is alkoxyalkyl alkylol melamine. The preferred organic cross-linking agent is methoxymethyl methylol melamine with a high methylol content and a high imino functionality. The preferred amount of organic cross-linking agent is from about 0.5 phr to about 5.0 phr of dry carboxylated nitrile latex rubber, more preferably about 0.6 phr to about 3.0 phr.

For the same tensile strength, the complex domain of the organic cross-linking agent and metal oxide of the invention produces articles with modulus lower than articles cured with metal oxide alone. Without being bound to theory of operation, it is believed that the complex domain functions as a flexible space arm that increases freedom of movement of the cross-linked nitrile polymer chains. This results in lower modulus and softer articles.

In the preferred embodiments, an antioxidant is added to decrease or inhibit oxidation degradation of nitrile latex articles during high temperature curing or long term storage. The required amount of antioxidant depends on cure temperature and cure time. The preferred antioxidant is polymeric hindered phenol (butylated reaction product of para-cresol and dicyclopentadiene). For articles of the invention made from carboxylated nitrile latex, aqueous anionic dispersion of antioxidant is added to nitrile latex. In preferred embodiments, polymeric hindered phenol is present in the range of about 0.1 phr to 2.0 phr, more preferably about 0.2 phr to about 1.0 phr. Other exemplary antioxidants include polybutylated bisphenol, 2,2′-methylenebis(4-methyl-6-t-butylphenol), and trifunctional hindered phenolic compounds.

Generally, the use of surface-active stabilizers in latex compositions can reduce gelled particles or chunks so defects in the articles made of the compositions are minimized. The amount of stabilizer needed is dependent of several factors such as the type and quantity of stabilizer already presented in raw nitrile latex, and the particle size, particle size distribution and pH of nitrile latex, and other factors. In this invention, when needed, sodium dodecylbenzene sulfonate is used as stabilizer with quantity in the range of 0.05 phr to 1.0 phr.

In preferred embodiments, dilute potassium hydroxide solution is used to adjust pH of nitrile latex compositions. The potassium hydroxide solution added is preferably in the amount to make the pH of the nitrile latex composition in the range about 8.8 to 9.8. In this pH range, stability of alkoxyalkyl alkylol melamine in nitrile latex composition of the invention is achieved, and runback and other physical appearance defects of dipped articles, such as gloves, are minimized.

II. Methods

Methods for preparation of nitrile latex compositions are known in the art. Generally, some ingredients can be added to the nitrile latex formulation at any time during compounding; however, other ingredients are added preferably in a specific order to optimize the stability of the composition. The first compounding method for preparing the compositions of the invention is a “one step” process by adding the compounding ingredients to carboxylated nitrile latex in the following sequence: surface active stabilizer solution (if required), water, pH adjustment solution, organic cross-linking agent, metal oxide dispersion, antioxidant dispersion, and pigment dispersions. Although the above sequence is preferred, it can be properly altered by people have ordinary skill in the art. The second compounding method for preparing the compositions of the invention is a “two steps” process. The first step is the preparation of the cross-linking complex dispersion by mixing together metal oxide dispersion, organic cross-linking agent, and antioxidant dispersion. The cross-linking complex dispersion is aged preferably for at least 3 days, more preferably at least 7 days at temperature from about 10 degree C. to about 30 degree C. The second step is the adding of all the compounding ingredients to nitrile latex. The preferred material compounding sequence for the “two steps” process is: nitrile latex, surface active stabilizer solution (if any), water, pH adjustment solution, cross-linking complex dispersion, additional metal oxide dispersion, and pigment dispersions. In the two steps process, the additional metal oxide dispersion is used to compensate for the metal oxide that is presumably consumed in the formation of the intra ionic bonds between the organic cross-linking agent and metal oxide within the complex domain. In both methods of the compounding process, the amount of pH adjustment solution used is to maintain the pH value of the finished latex compositions between 8.8 to 9.8. The latex compositions prepared are free of accelerators and sulfur. After all the ingredients are added, under proper agitation the latex composition is preferably aged for one to three days, more preferably from one to two days, before use. This aging period allows air to escape, compounding ingredients to form homogeneous mixture, and maturation of latex to improve latex quality and finished article properties. For compositions contain the same total amount of metal oxide, the “two steps” process produces articles with lower modulus than the “one step” process.

For glove dipping operation, the glove formers are cleaned first by dipping in soap solution, wiping with brushes, and rinsing with water. The cleaned formers are dried by heat and dipped in coagulant. Powder-free coagulant consists of calcium salts (calcium nitrate or calcium chloride), surfactant, and water. Modified cornstarch absorbable dusting powder or calcium carbonate powder can be added to the powder-free coagulant to make powdered coagulant. Both types of coagulant can be used for making accelerator-free nitrile gloves. The coagulant-coated formers are heated and dipped in latex composition. The wet latex films on glove formers are properly dried before they are dipped in warm water to leach out undesirable water-soluble substances. The formers with leached films are dipped in stripping lubricant. Proprietary polymer coatings can be used as powder free stripping lubricants, and powder dispersions containing absorbable dusting powder, surfactant and water can be used as powdered stripping lubricants. Absorbo HP and Keoflo 7136p are typical USP grade, modified cornstarch powders, which are suitable for use as absorbable dusting powder on medical gloves. The lubricant-coated films on formers are dried and cured in oven. The cure temperature is preferably from about 90 degree C. to about 150 degree C., more preferably from about 100 degree C. to about 130 degree C. The cure time is preferably from about 60 minutes to about 10 minutes, more preferably from about 30 minutes to 15 minutes. Lower cure temperature requires longer cure time, and higher cure temperature requires shorter cure time. For stripping, the cured glove films on formers are cooled to from about 50 degree C. to about 70 degree C. The stripped gloves are further treated with a tumbling process. Typical tumbling process is set at temperature from about 50 degree C. to about 80 degree C. and tumbling time from about 20 minutes to about 40 minutes. Then a cooling cycle of about 10 minutes to 20 minutes is used to cool the gloves. For powdered gloves, the tumbled gloves are the finished products. For powder-free gloves, the tumbled gloves are further processed. Chlorination is generally carried out by contacting gloves with a solution containing chlorine. Hypochlorite salts and compressed chlorine gas are the key sources to provide chlorine in aqueous solution. Chlorination process is used to remove powder and/or make glove surface non-tacky and slippery.

### EXAMPLE 1

As shown in Table 1 below, a master batch of cross-linking complex dispersion was prepared by mixing together methoxymethyl methylol melamine (organic cross-linking agent), zinc oxide dispersion, and polymeric hindered phenol. The dispersion was allowed to age for at least 7 days at temperature between 10 to 30 degree C. before it was used to mix with other components of the composition.

TABLE 1
Master Batch of Cross-linking Complex Dispersion

| | |
|---|---|
| Methoxymethyl methylol melamine | 32.8% |
| Zinc oxide | 16.4% |
| Polymeric hindered phenol | 6.8% |
| Water (from dispersions & added) | 44% |

The % was in weight basis.
The solids content was 56%.

A carboxylated nitrle latex composition was prepared with the amount of each component shown in Table 2. All amounts are expressed in parts per hundred parts of dry nitrile rubber (phr).

TABLE 2

| | | |
|---|---|---|
| Carboxylated nitrile latex (Nantex 630E) | 100 | phr |
| Potassium hydroxide | 0.6 | phr |
| Titanium dioxide | 2.8 | phr |
| Phthalocyanine salt | 0.04 | phr |
| Table 1: Master Batch of Cross-linking Complex | 2.05 | phr |
| Zinc oxide | 0.4 | phr |

Soft (deionized) water: quantity needed was to make the the compounded latex composition with a solids content of about 27% to about 31%.

To begin compounding, the calculated amount of carboxylated nitrile latex (Nantex 630E) was fed through a strainer bag into a mixing vessel. The addition of compounding ingredients to the latex was in the following sequence: soft water, dilute potassium hydroxide solution, master batch cross-linking complex dispersion, additional zinc oxide dispersion, titanium dioxide dispersion, and phthalocyanine salt dispersion. It is well-known in the art that to avoid shock (instability) to latex all the dispersions should be properly diluted with soft (deionized) or distilled water before adding them to latex. The latex was stirred throughout the whole compounding procedure. The agitator was set at a speed that was sufficient to promptly mix the added components into latex but was not too high to induce foaming and latex instability.

Glove formers were cleaned in a detergent solution, brushed, and rinsed. The glove formers were heated and dipped into a coagulant containing calcium nitrate, water, and a nonionic surfactant. The coagulant-coated formers were heated and dipped in the latex compound. The dry coagulant induced the aggregation of nitrile latex to form a film around the glove formers. The latex-coated formers were dipped into warm water to leach out undesirable water-soluble substances, and then dipped into a powder slurry consisting of lightly cross-linked cornstarch, USP (United States Pharmacopoeia) grade absorbable dusting powder, and a surfactant. The formers with powder-coated latex films were then placed in an oven for 15 to 25 minutes at 110 to 130 degree C. to cure the latex glove films. The cured gloves on formers were heat dried and then cooled to about 50 to about 70° C. for stripping. This method produced powdered gloves.

The tensile properties of the carboxylated nitrile gloves made per composition and process of the example described herein were tested and summarized in Table 3 below:

TABLE 3

| Tensile strength | 35.4 MPa (5,133 PSI) |
|---|---|
| 300% modulus | 4.3 MPa (623 PSI) |
| Ultimate elongation | 675% |

When the cure system of this invention was replaced by the conventional cure system consisting of accelerators, sulfur and zinc oxide, the typical tensile properties of the cured nitrile gloves were tested and shown in Table 4 below:

TABLE 4

| Tensile strength | 34.3 MPa (4,974 PSI) |
|---|---|
| 300% modulus | 4.3 MPa (624 PSI) |
| Ultimate Elongation | 621% |

### EXAMPLE 2

By eliminating the 0.4 phr additional zinc oxide in Table 2, the tensile property of the cured gloves is shown in Table 5 below.

TABLE 5

| Tensile strength | 27.9 MPa (4,046 PSI) |
|---|---|
| 300% modulus | 1.8 MPa (261 PSI) |
| Ultimate elongation | 780% |

The 300% modulus and ultimate elongation shown in Table 3 and Table 5 illustrate the significant effect of the ratio of alkoxyakyl akylol melamine to zinc oxide on softness of the cured gloves.

Although carboxylated nitrile latex compositions and articles are used as examples in this specification, the concept and scope of this invention are applicable to other carboxylated latexes. These and other modifications and variations to the present invention may be practiced by those who have ordinary skill in the art, without departing from the concept and scope of the present invention, which are described above. Furthermore, it should be understood that the foregoing description is by the way of example only and is not intended to limit the invention, and that aspects of various embodiments may be interchanged in whole or in part.

What is claimed is:

1. A process of making an elastomeric carboxylated nitrile latex articles comprising the steps of: a) preparing a compounded latex composition containing an accelerator-free composition, said accelerator-free composition comprising a mixture of alkoxyalkyl alkylol melamine and metal oxide as the cure system; b) dipping a former into said compounded latex composition to form a gelled film; and c) curing said gelled compounded latex composition film on said former to form said elastomeric carboxylated nitrile latex article.

2. The process of claim 1, wherein said elastomeric carboxylated nitrile latex article is a glove.

3. The process of claim 1, wherein said elastomeric carboxylated nitrile latex article is a finger cot.

4. The process of claim 1, wherein said elastomeric carboxylated nitrile latex article is a sleeve.

5. The process of claim 1, wherein said accelerator-free composition comprises: alkoxyalkyl alkylol melamine and zinc oxide.

6. The process of claim 1, wherein said accelerator-free composition comprises: alkoxyalkyl alkylol melamine and zinc oxide in phr (parts per hundred parts of dry rubber) ratio of from about 0.5 to 5.0 phr alkoxyalkyl alkylol melamine and about 0.5 to 2.0 phr zinc oxide, per 100.0 phr nitrile of the compounded latex composition.

7. A synthetic elastomeric carboxylated nitrile latex article having a tensile strength of greater than 2100 psi and less than 5500 psi as measured in accordance with ASTM D412, said article being prepared by a process comprising the steps of: a) preparing a compounded latex composition containing an accelerator-free composition, said accelerator-free composition comprising alkoxyalkyl alkylol melamine and zinc oxide.

8. The article of claim 7, wherein the article is a glove.

9. The article of claim 7, wherein the article is a finger cot.

10. The article of claim 7, wherein the article is a sleeve.

11. The article of claim 7, wherein said accelerator-free composition comprises: alkoxyalkyl alkylol melamine and zinc oxide in phr ratio of from about 0.5 to 5.0 phr alkoxyalkyl alkylol melamine and about 0.5 to 2.0 phr zinc oxide, per 100.0 phr nitrile of the compounded latex composition.

12. The article of claim 7, wherein the 300% modulus of the article is adjusted by varying the phr ratio of alkoxyakyl alkylol melamine to zinc oxide.
